(19) United States
(12) Patent Application Publication
(10) Pub. No.: US 2024/0107363 A1
(43) Pub. Date: Mar. 28, 2024

(54) STATISTICAL DELAY REPORTING FOR ADAPTIVE CONFIGURATION OF DELAY BUDGET

(71) Applicant: QUALCOMM Incorporated, San Diego, CA (US)

(72) Inventors: Diana MAAMARI, San Diego, CA (US); Linhai HE, San Diego, CA (US); Prashanth Haridas HANDE, San Diego, CA (US); Hyun Yong LEE, San Diego, CA (US); Ahmed ELSHAFIE, San Diego, CA (US); Huilin XU, Temecula, CA (US)

(21) Appl. No.: 17/935,535

(22) Filed: Sep. 26, 2022

(51) Int. Cl. H04W 28/02

(52) U.S. Cl. CPC H04W 28/0268; H04W 28/0236

(57) ABSTRACT

Apparatuses and methods for statistical delay reporting for adaptive configuration of delay budget are described. An apparatus is configured to measure delay statistics, at a UE, that correspond to a delay budget for traffic associated with LCHs. The apparatus is configured to transmit, to a network entity, a report associated with the traffic for the LCHs. The report including an indication of the delay statistics that correspond to the delay budget. Another apparatus is configured to receive, from a UE, a report associated with traffic that is associated with LCHs, the report including an indication of measurements associated with delay statistics, measured at the UE, that correspond to a delay budget for the traffic that is associated with the LCHs. The other apparatus is configured to transmit, for the UE, a delay budget configuration that adjusts a delay parameter at the UE for at least one of the LCHs.

### TECHNICAL FIELD

The present disclosure relates generally to communication systems, and more particularly, to wireless communications utilizing adaptive delay budget configurations.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to measure one or more delay statistics, at the UE, that correspond to a delay budget (DB) for traffic associated with one or more logical channels (LCHs). In addition, the apparatus is configured to transmit, to a network entity, a report associated with the traffic for the one or more LCHs, the report including an indication of the one or more delay statistics that correspond to the DB.

In the aspect, the method includes measuring one or more delay statistics, at the UE, that correspond to a delay budget (DB) for traffic associated with one or more logical channels (LCHs). In addition, the method includes transmitting, to a network entity, a report associated with the traffic for the one or more LCHs, the report including an indication of the one or more delay statistics that correspond to the DB.

In another aspect of the disclosure, a method, a computer-readable medium, and an apparatus are provided for wireless communication at a network node. The apparatus is configured to receive, from a user equipment (UE), a report associated with traffic that is associated with one or more logical channels (LCHs), the report including an indication of measurements associated with one or more delay statistics, measured at the UE, that correspond to a delay budget (DB) for the traffic that is associated with the one or more LCHs. In addition, the apparatus is configured to transmit, for the UE, a DB configuration that adjusts a delay parameter at the UE for at least one of the one or more LCHs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example extended reality (XR) traffic, in accordance with various aspects of the present disclosure.

FIG. 5 is a call flow diagram for wireless communications, in accordance with various aspects of the present disclosure.

FIG. 6 is a call flow diagram for wireless communications, in accordance with various aspects of the present disclosure.

FIG. 7 is a flow diagram for adaptive configuration of delay budget in wireless communications, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a diagram illustrating an example of a hardware implementation for an example apparatus and/or UE, in accordance with various aspects of the present disclosure.

FIG. 13 is a diagram illustrating an example of a hardware implementation for an example network entity in accordance with various aspects of the present disclosure.

### DETAILED DESCRIPTION

Some wireless communication may include traffic with short deadlines that benefits from low latency. As an example, extended reality (XR) traffic may have short timeframes for exchange. Longer latency for traffic flows may reduce a user experience with an XR application or device. Aspects presented herein provide aspects to improve the efficient communication of delay sensitive traffic. Various aspects herein relate to statistical delay reporting for adaptive configuration of a delay budget (DB). A wireless communication network, such as a 5G NR network, may be designed to include a fixed end-to-end (e2e) packet DB between a user equipment (UE) and an application server, for uplink and downlink communications. After an amount of time corresponding to the DB elapses, the data packets may be treated as obsolete and are discarded. The fixed e2e packet DB (or e2e “PDB”), however, may be a conservative estimate of data packet obsolescence due to jitter experienced during communications through the network. The described aspects enable a UE to measure and report UE delay statistics that correspond to a DB for traffic associated with one or more logical channels (LCHs) and to implement adaptive configurations of DB s, which allows improved transmission and management of data packets in XR flows to prevent the data packets from becoming obsolete to an application and discarded once their delay exceeds the DB. The described aspects also improve efficiency in the use of radio resources, e.g., in handling large, high data-rate flows such as video (e.g., in XR).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, a gNB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

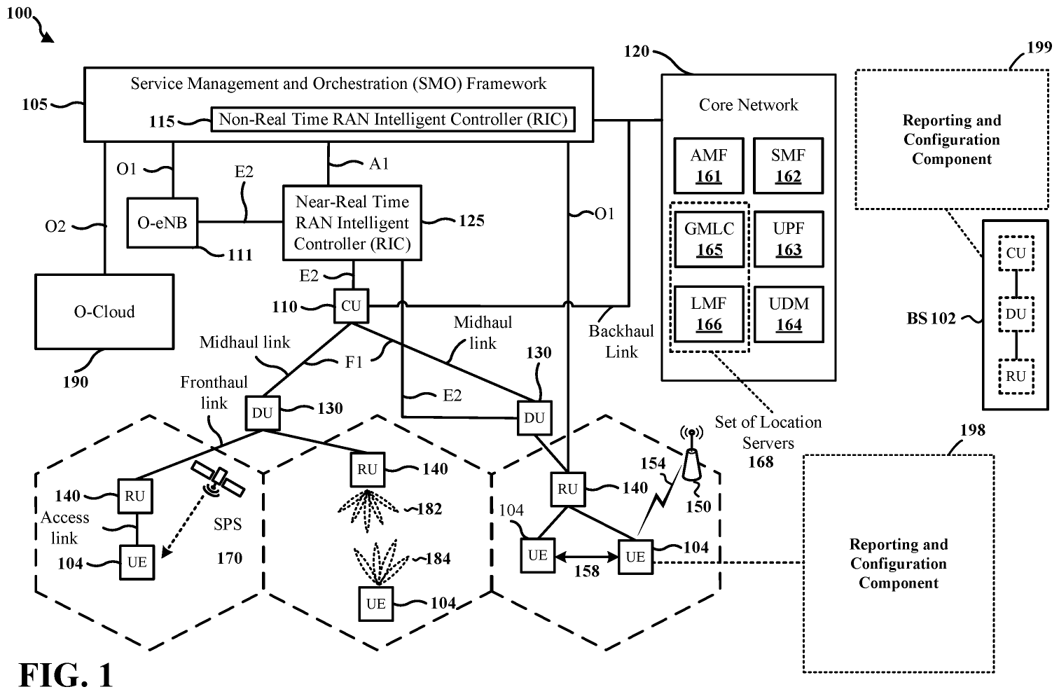

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a reporting and configuration component 198 (“component 198”) that is configured to measure one or more delay statistics, at the UE, that correspond to a delay budget (DB) for traffic associated with one or more logical channels (LCHs). The component 198 is also configured to transmit, to a network entity, a report associated with the traffic for the one or more LCHs, the report including an indication of the one or more delay statistics that correspond to the DB. In some aspects, the component 198 may be configured to transmit a scheduling request to the network entity for a resource to transmit the report, and receive, from the network entity, a grant of the resource, where to transmit the report, the component 198 may be configured to transmit the report in the resource granted by the network entity. In some aspects, the component 198 may be configured to receive, prior to the report being transmitted, a configured grant that allocates resources to the UE, where to transmit the report, the component 198 may be configured to transmit the report in a resource of the configured grant. In some aspects, the component 198 may be configured to transmit, to the network entity, a subsequent report associated with subsequent traffic for the one or more LCHs, the subsequent report including a delta indication of a difference between of the one or more delay statistics that correspond to the DB in a prior report and one or more subsequently measured delay statistics that correspond to the DB. In some aspects, where the traffic associated with the one or more LCHs is at least one of uplink traffic, downlink traffic, or sidelink traffic, the component 198 may be configured to receive, from the network entity, a DB configuration that adjusts a delay parameter at the UE for at least one of the one or more LCHs, and communicate further subsequent traffic with the network entity according to the DB configuration. In some aspects, the component 198 may be configured to receive, from the network entity, a configuration for the report of the one or more delay statistics, the configuration including at least one physical uplink control channel (PUCCH) resource for the report, where to transmit the report, the component 198 may be configured to transmit the report via the at least one PUCCH resource.

In certain aspects, the base station 102, or the UE 104 (e.g., when configured as a relay UE attached to the network, as shown D2D communication 158 (e.g., sidelink communications), may include a reporting and configuration component 199 (“component 199”) that is configured to receive, from a user equipment (UE), a report associated with traffic that is associated with one or more logical channels (LCHs), the report including an indication of measurements associated with one or more delay statistics, measured at the UE, that correspond to a delay budget (DB) for the traffic that is associated with the one or more LCHs. The component 199 is also configured to transmit, for the UE, a DB configuration that adjusts a delay parameter at the UE for at least one of the one or more LCHs. In some aspects, the component 199 may be configured to receive a scheduling request, from the UE, for a resource for transmission of the report, and to transmit, to the UE, a grant of the resource responsive to the scheduling request; or may be configured to transmit, prior to the report being received, a configured grant allocating resources to the UE, where to receive the report, the component 199 is configured to receive the report in another resource of the configured grant. In some aspects, the component 199 may be configured to transmit, for the UE, an updated DB configuration that adjusts the delay parameter at the UE for the at least one of the one or more LCHs based on a subsequent report received from the UE that is associated with subsequent traffic for the one or more LCHs, the subsequent report including a delta indication of a difference between of the one or more delay statistics that correspond to the DB and one or subsequently measured more delay statistics that correspond to the DB, and to communicate further subsequent traffic with the UE according to the DB configuration. In some aspects, the component 199 may be configured to transmit, for the UE, a configuration for the report for the one or more delay statistics, the configuration including at least one physical uplink control channel (PUCCH) resource for the report.

Although the following description may be focused on 5G NR and XR by way of example, the concepts described herein may be applicable to other similar areas, such as LTE, LTE-A, CDMA, GSM, and other wireless technologies, as well as other applications, traffic, and/or data.

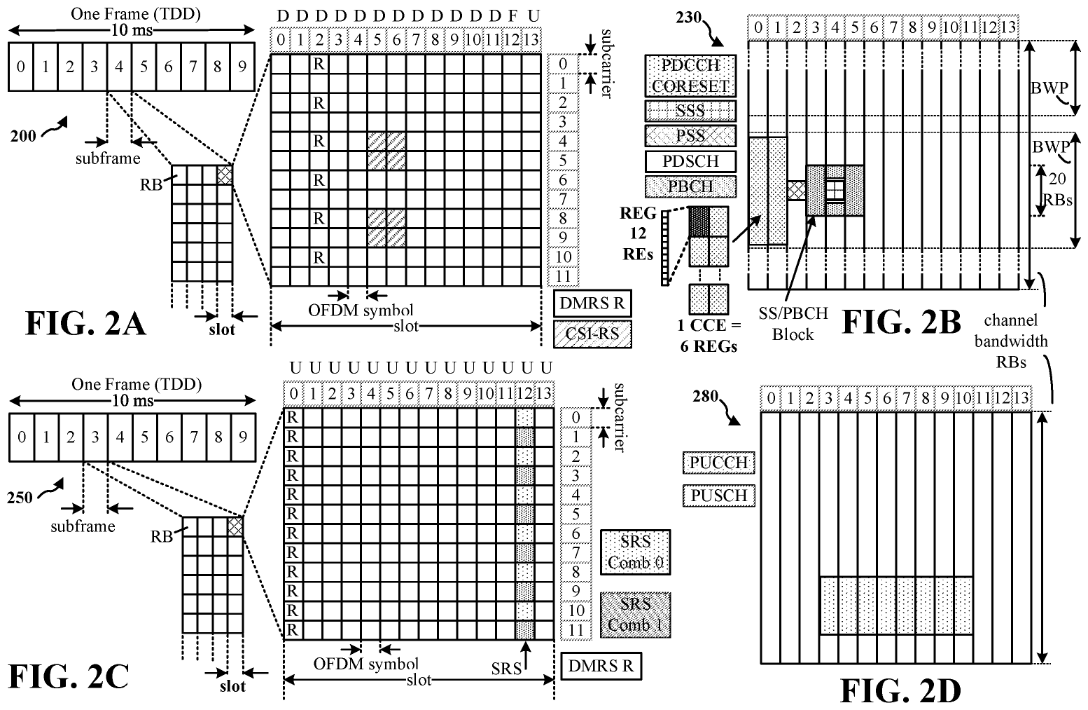

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology 1.1=4 has a subcarrier spacing of 240 kHz. The symbol length/duration is inversely related to the subcarrier spacing. FIGS. 2A-2D provide an example of normal CP with 14 symbols per slot and numerology 1.1=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

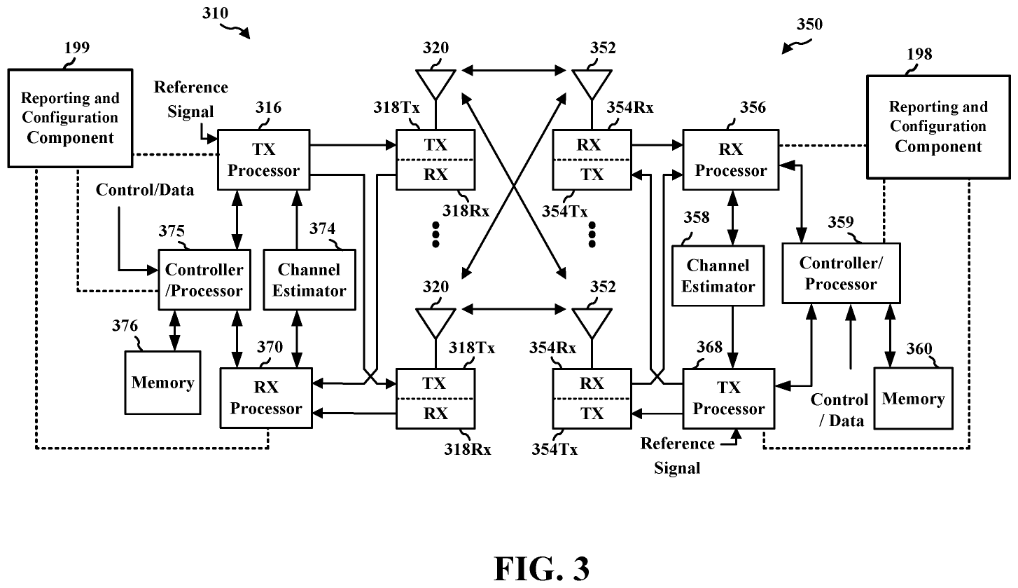

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the reporting and configuration component 198 of FIG. 1.

At least one of the TX processor 316, the RX processor 370, and the controller/processor 375 may be configured to perform aspects in connection with the reporting and configuration component 199 of FIG. 1.

Aspects described herein for statistical delay reporting for adaptive configuration of a DB provide enhancements to the implementation of the fixed end-to-end (e2e) packet DB (PDB) included in a wireless network, such as a 5G NR network among other example networks in which an e2e PDB may be applied. Some flows generated by XR and other applications have tight deadlines given the requirements of the user experience for such applications and the bandwidth required for the data flows— packets in these flows become obsolete to the application once their packet delay exceeds the e2e PDB.

While delay sensitive UL traffic may be transmitted via configured grant resources, which may be sufficient for small-sized, constant data-rate flows (e.g., pose), dynamic grant resources may still be needed to handle larger, high data-rate flows (e.g., video) in order to efficiently use radio resources.

The e2e PDB between a UE and an application server may be insufficient to serve as a guideline for preventing packet obsolescence, and may be not practical for a UE to apply in its layer 2 (L2) procedures. For downlink traffic, a UE does not know the routing delay through the core network (CN) (e.g., such as 120 in FIG. 1) and the scheduling delay at a base station (e.g., 102 in FIG. 1) for each individual packet, which contribute to the DL packet delay. For uplink traffic, a base station may not know the delay of each packet before it is transmitted on a PUSCH from a UE, which contributes to the UL packet delay. If a network configures a pair of UE-side e2e PDBs for a LCH or a data radio bearer (DRB), for the DL traffic, the e2e PDB may correspond to the maximum delay from the time when a PDCCH for a TB is received to the time when data is delivered to the application, while for uplink traffic, the e2e PDB may be the maximum delay from the time when data is generated by the application to the time when a TB is transmitted in a PUSCH. A residual delay budget (RDB) may be a remaining portion of an overall PDB (e.g., after the e2e PDB for the packet delay of DL/UL) that a PDU has before it becomes obsolete and is discarded— that is, the overall PDB may include the e2e PDB (e.g., the delay allowed to a transmitted packet) and the RDB. If the network configures or determines whether an LCH needs to report delay statistics at the UE based on the overall PDB, the actual packet delays experienced for the UE on the LCH may be unaccounted for by the network, and the fixed e2e PDB may be an overly-conservative estimate of data packet obsolescence due to the jitter experienced during communications through the network.

The described aspects enable a UE to measure and report UE delay statistics that correspond to a DB for traffic associated with one or more logical channels (LCHs) and to then implement adaptive configurations of DB s, e.g., taking experienced delays due to jitter and/or the like, which allows improved transmission and management of data packets in XR flows to prevent the data packets from becoming obsolete to an application and discarded once their delay exceeds the DB. The described aspects also improve efficiency in the use of radio resources, e.g., in handling large, high data-rate flows such as video (e.g., in XR). While various aspects may be described in the context of XR for descriptive and illustrative purposes, aspects are not so limited and are applicable to other types of applications, traffic, and/or data, as would be understood by persons of skill in the relevant art(s) having the benefit of this disclosure.

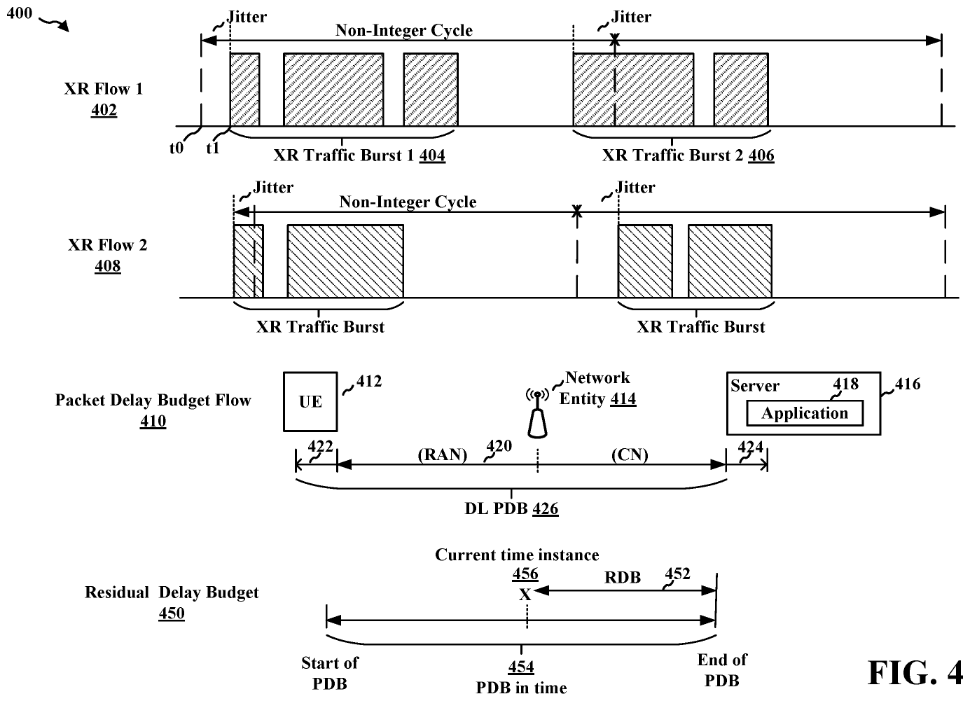

FIG. 4 is a diagram 400 illustrating example XR traffic, in various aspects. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The diagram 400 illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time t0, but the first packet of the first XR traffic burst 404 arrives at time t1.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

As noted herein, XR traffic may have an associated e2e PDB. If a packet does not arrive within the e2e PDB, a UE (or a base station) may discard the packet. In an example, if a packet corresponding to a video frame of a video does not arrive at a UE within an e2e PDB, the UE may discard the packet, as the video has advanced beyond the frame. However, the RDB at the UE may be unaccounted for in consideration of discarding packets. An example time diagram 450 shows a length of time corresponding to a PDB 454. At a particular point in time 456, the residual delay budget 452 is the remaining portion of the PDB 454.

An XR traffic overall PDB may include a portion to allow for communication delay of data (e2e PDB) between a UE and a computing device, e.g., a server, hosting an application, e.g., for XR, and a portion for additional time after the communication delay before the data is discarded, e.g., residual delay (e.g., RDB). For instance, the diagram 400 includes a packet delay budget flow 410. Packet delay budget flow 410 illustrates a UE 412, a network entity 414, and a server 416 that hosts an application 418. In the illustrated aspect, a communication delay 420 is shown as including a RAN portion between the UE 502 and the network entity 414, as well as a CN portion between the network entity 414 and the server 416. The communication delay 420 may apply to both UL and DL communications. Additionally, a residual delay 422 is shown at the UE 412 for DL communications and a residual delay 424 is shown at the server 416 for UL communications. The communication delay 420 and the residual delay 422 may make up an overall PDB for DL XR communications, e.g., DL PDB 426. Likewise, the communication delay 420 and the residual delay 424 may make up an overall PDB for UL XR communications (not shown for illustrative clarity).

In general, XR traffic may be characterized by relatively high data rates and low latency. The latency in XR traffic may affect the user experience. For instance, XR traffic may have applications in eMBB and URLLC services.

Various aspects may be employed to provide power saving and/or capacity improvement for wireless communication, e.g., including XR traffic. Scheduling mechanisms such as semi-persistent scheduling (SPS) or a configured grant (CG) may be used to provide periodic resources for UL or DL communication that can be used without a dynamic grant of resources. Some types of wireless communication systems may employ dynamic grants for scheduling purposes to accommodate traffic (e.g., XR traffic). In a dynamic grant, a scheduler, e.g., such as a network entity, may use control signaling to allocate resources for transmission or reception at a UE (e.g., a grant of UL or DL resources). Dynamic grants may be flexible and can adopt to variations in traffic behavior. The CG may provide periodic or semi-static resources, e.g., that a UE can use for to transmit or receive communication without receiving individual grants. For example, a UE may receive a configured grant in an RRC configuration. The UE may then use the granted resources for transmission and/or reception without additional DCI. In some aspects, the UE may receive a MAC-CE activating a previously configured CG. For wireless communication that is based on a dynamic grant, the UE may monitor for a PDCCH including a DCI that schedules the UE, e.g., allocates particular resources to the UE, to transmit or receive communication with a base station (e.g., instructions to receive data over a PDSCH). In some aspects, such as when a UE has data to transmit, the UE may transmit a scheduling request to a network entity to trigger the network entity to allocate resources for the transmission, such as in DCI. Various aspects also provide a UE to request for a dynamic grant (DG) of a resource for UL communication, e.g., reporting measured delay statistics. The SPS or CG scheduling may be configured to accommodate the periodic traffic, multiple flows, jitter, latency, and reliability for the wireless traffic and may improve capacity and/or latency for such wireless communication. The DG requests/provisions may similarly accommodate multiple flows, jitter, latency, and reliability for the wireless traffic and may improve capacity and/or latency for such wireless communication for urgent reporting of measured delay statistics and/or for reporting measured delay statistics in cases where a CG or other uplink resource is not available. Traffic bursts, such as XR bursts by way of example, are periodic and may include some time jitter in the arrival. Aspects presented herein provide for the UE to measure and report delay statistics for LCHs to enable e2e PDB/overall PDB configurations to account for jitter and latency of data packets, and improve quality, reliability, and utilization for resources and for the wireless traffic such as XR traffic among other examples.

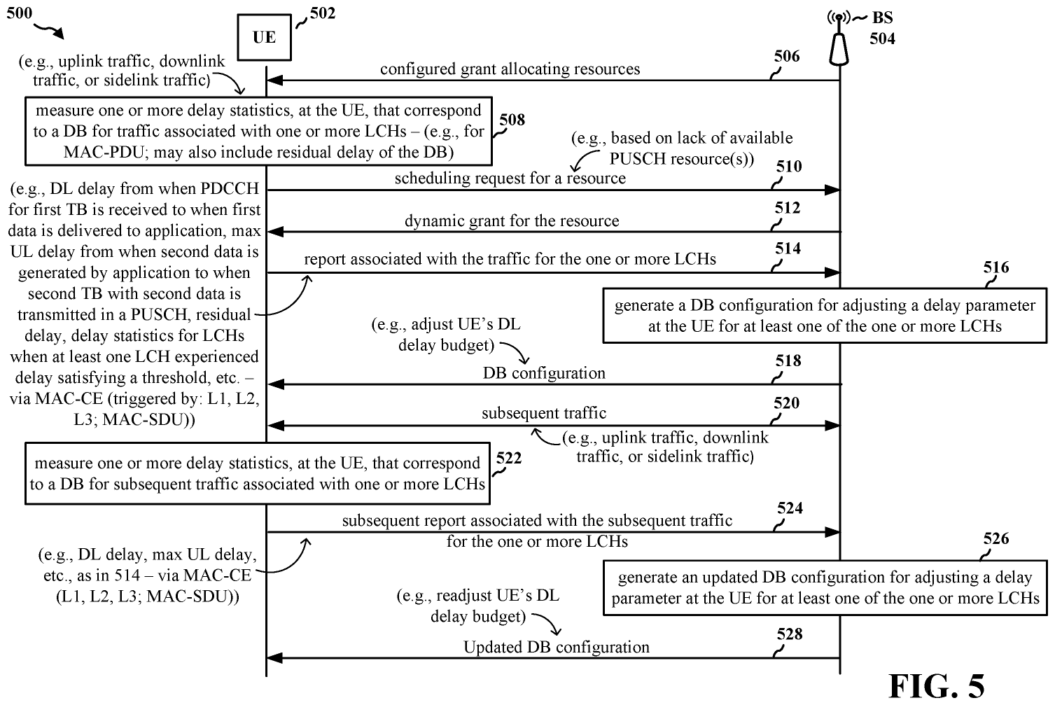

FIG. 5 shows a call flow diagram 500 for wireless communications, in various aspects. Call flow diagram 500 illustrates adaptive configuration of delay budgets in wireless communications through delay statistic reporting, and illustrates configuring a UE 502 for statistical delay reporting to a network entity (a base station 504, such as a gNB or other type of base station, by way of example, as shown), in various aspects. Aspects described for the base station 504 may be performed by the base station in aggregated form and/or by one or more components of the base station in disaggregated form. Additionally, or alternatively, the reporting aspects may be performed by a UE 502 that communicates based on sidelink, e.g., and may be provided to a base station and/or a UE for sidelink communication.

In the illustrated aspect, the UE 502 receives a CG 506 allocating resources that is transmitted by the base station 504 or one or more components thereof. The CG may be transmitted from base station via RRC, in aspects. The UE 502 measures, at 508, one or more delay statistics, at the UE 502, that correspond to a DB (e.g., an e2e DB) for traffic associated with one or more logical channels LCHs. In one configuration, the traffic may include a MAC-PDU, and the one or more delay statistics that correspond to the DB are associated with the MAC-PDU from a LCH of the one or more LCHs. In aspects, a residual delay of the DB may also be measured. In some configurations, the traffic associated with the one or more LCHs may be least one of uplink traffic, downlink traffic, or sidelink traffic (e.g., from another UE acting as a “network entity”).

In some aspects, the resources allocated by the CG 506 (e.g., a PUSCH resource(s)) may be present and available for providing a report 514, with delay statistics, that is associated with the traffic for the one or more LCHs. In one configuration, e.g., if such a resource is not available, a scheduling request 510, for a resource to transmit the report 514, may be transmitted to the base station 504. The base station 504 may transmit a DG 512 for the resource to the UE 502 in response to the scheduling request 510. In such aspects, the report 514 may be transmitted to the base station 504 in the resource granted thereby. In either case, the report 514, with delay statistics, that is associated with the traffic for the one or more LCHs may be transmitted to the base station 504. The report 514 may be comprised in a medium access control (MAC) control element (MAC-CE) on a PUSCH. In various configurations, the delay statistics in the report 514 may include a downlink delay from a first time when a PDCCH for a first TB is received to a second time when first data is delivered to an application, a maximum uplink delay from a third time when second data is generated by the application to a fourth time when a second TB with the second data is transmitted in a PUSCH, and/or the like. In aspects, the report 514 may be transmitted to the base station 504 responsive to, or as triggered by, at least one of a layer 1 (L1), a layer 2 (L2), or a layer 3 (L3) signaling received from the base station 504. In one aspect, the UE 502 is configured to measure a RDB, for downlink (DL) traffic of the traffic, associated with a time difference between (1) an end of the DB of the UE 502 that is configured by the base station 504 and (2) a delivery deadline required by an application for the DL traffic, and include this measurement in the report 514. In aspects, the delay statistics that correspond to the DB may include a first order delay statistic, a second order delay statistic, a mean value for the one or more delay statistics taken over a window of time, a variance for the one or more delay statistics taken over the window of time, or a standard deviation for the one or more delay statistics taken over the window of time. In one configuration, the report 514 may be transmitted to the base station 504 responsive to, or as triggered by a MAC SDU, from an LCH of the one or more LCHs, having an experienced delay at the UE 502 that satisfies a threshold.

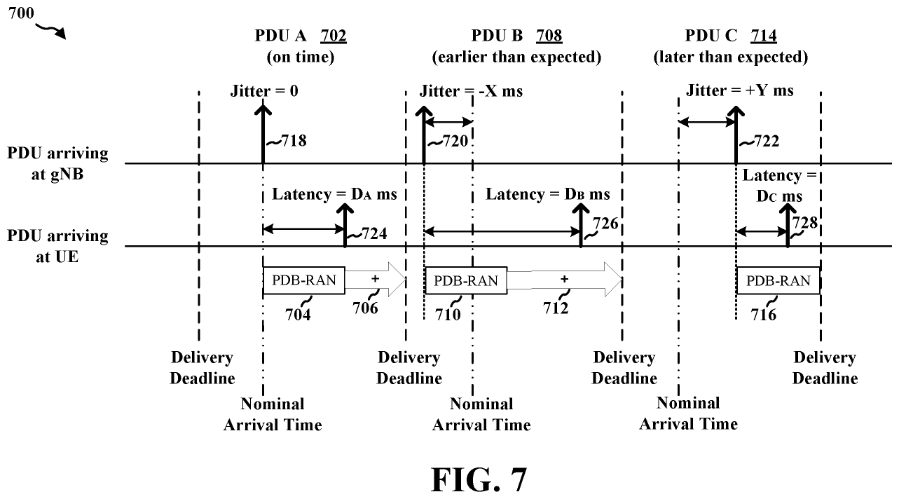

Based on the report 514, the base station 504 may generate at 516 a DB configuration 518 that adjusts a delay parameter at the UE 502 for at least one of the one or more LCHs. In one configuration, the DB configuration 518 may include an adjustment(s) to lengthen, shorten, or otherwise adjust an e2e PDB of the UE 502, e.g., for the DL DB of the UE 502 (as described in addition detail below with respect to FIG. 7). The DB configuration 518 is transmitted from the base station 504 to the UE 502, and the UE 502 implements the configuration to apply the adjustment(s). Subsequent to applying the DB configuration 518 at the UE 502, subsequent traffic 520 is communicated between the UE 502 and the base station 504. The subsequent traffic 520 may be uplink traffic, downlink traffic, and/or sidelink traffic (e.g., with another UE configured as a network entity).

The UE 502 may measure at 522 one or more delay statistics, at the UE 502, that correspond to a DB (e.g., an e2e DB) for the subsequent traffic 520 associated with one or more logical channels LCHs. The UE 502 may be configured to measure the one or more delay statistics that correspond to the DB for the subsequent traffic 520 at 522 as similarly described above (at 508). The UE 502 may generate and transmit a subsequent report 524 associated with the subsequent traffic 520 for the one or more LCHs. In aspects, the subsequent report 524 may include a delta indication of a difference between of the one or more delay statistics that correspond to the DB in a prior report (e.g., report 514) and one or more subsequently measured delay statistics (e.g., at 522) that correspond to the DB. In one configuration, the UE 502 may transmit the subsequent report 524 in resources allocated by the CG 506, while in another configuration, the UE 502 may transmit the subsequent report 524 in resources allocated by the DG 512 (requesting and receiving as described above).

Based on the subsequent report 524, the base station 504 may generate at 526 an updated DB configuration 528 that adjusts/readjusts a delay parameter at the UE 502 for at least one of the one or more LCHs, e.g., as similarly described above (at 516). The UE 502 may then receive, from the base station 504, and apply the updated DB configuration 528 that adjusts the delay parameter at the UE 502 for at least one of the one or more LCHs. The UE 502 may then communicate further subsequent traffic with the base station 504 according to the updated DB configuration 528.

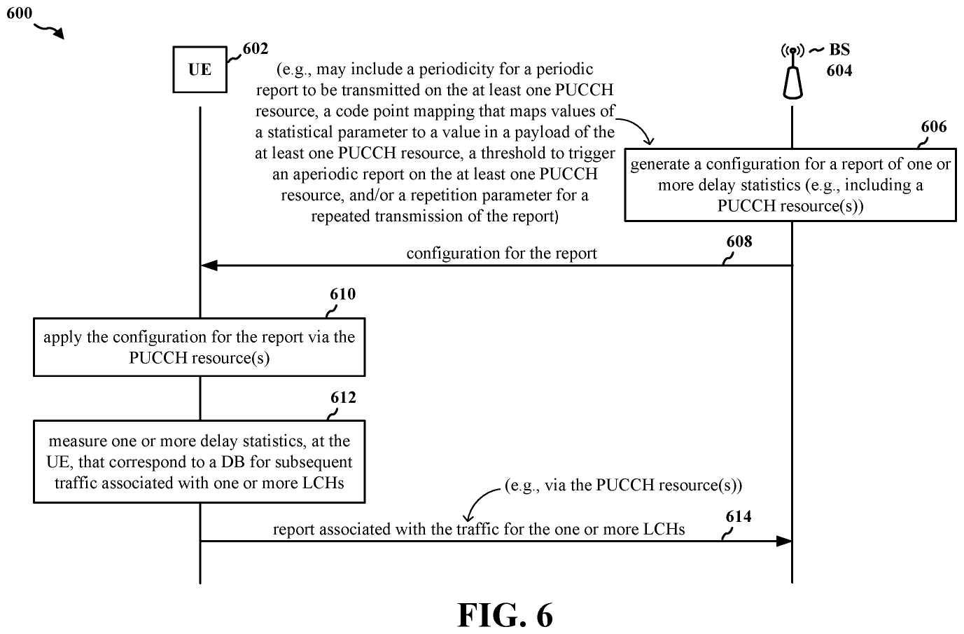

FIG. 6 shows a call flow diagram 600 for adaptive configuration of delay budget in wireless communications, in various aspects. Call flow diagram 600 illustrates configuring a UE 602 for statistical delay reporting over a PUCCH to a network entity (a base station 604, by way of example in the illustrated aspect). Additionally, or alternatively, the aspects described in connection with FIG. 6 may be performed by a UE 602 that communicates based on sidelink, e.g., and may be provided to a base station and/or a UE for sidelink communication.

Call flow diagram 600 may be an alternative aspect of call flow diagram 500 in FIG. 5 for report configuration (e.g., reporting via PUCCH in call flow diagram 600 in addition to, or in lieu of, reporting via MAC-CE in call flow diagram 500), and it is contemplated herein that call flow diagram 600 may include other commensurate portions of call flow diagram 500 in non-illustrated aspects.

In the illustrated aspect, the base station 604 generates at 606 a configuration 608 for a report of one or more delay statistics. The configuration 608 for the report of the one or more delay statistics may include a PUCCH resource(s) in which the UE 602 is enabled to provide the report to the base station 604. The configuration 608 for the report may include or identify which LCH(s) is/(are) enabled for statistical delay reporting. In an aspect, the UE may report urgent delay statuses/statistics of its enabled LCH(s). The configuration 608 may also include a periodicity for a periodic report to be transmitted on the at least one PUCCH resource, a code point mapping that maps values of a statistical parameter to a value in a payload of the at least one PUCCH resource, a threshold to trigger an aperiodic report on the at least one PUCCH resource, and/or a repetition parameter for a repeated transmission of the report. In aspects, the reporting of the statistical delay may be periodic/aperiodic or semi-persistent. In addition, for each enabled LCH, the codepoint mapping for respective portions of the report for statistical delay (e.g., if a PUCCH resource for the report can only support a 3-bit payload), the codepoint mapping may describe how possible values of statistical parameters are mapped to a value in the PUCCH payload. In aspects, the configuration 608 for the report may also include one or more triggers associated with providing the report via the PUCCH (e.g., an L1, an L2, or an L3 signaling received from the network entity, a MAC SDU, from a LCH having experienced delay at the UE that satisfies a threshold, etc.). In aspects, the configuration 608 for the report 614 may include a number of times that the report 614 be repeatedly transmitted via the PUCCH (e.g., periodically/aperiodically, semi-persistently, etc.).

The base station 604 may transmit the configuration 608 for the report to the UE 602, and subsequently, the UE 602 may apply at 610 the configuration 608 for the report via the PUCCH, e.g., via the PUCCH resource(s). At 612, the UE may measure one or more delay statistics, at the UE, that correspond to a DB for subsequent traffic associated with one or more LCHs, e.g., for MAC-PDU, as similarly described above for (508) in FIG. 5. The measuring at 612 may include residual delay of the DB, in aspects, and the traffic may be uplink traffic, downlink traffic, and/or sidelink traffic.

The report 614 associated with the traffic for the one or more LCHs may be transmitted from the UE 602 and received at the base station 604. The report 614 associated with the traffic for the one or more LCHs may be transmitted responsive to being triggered by a trigger, e.g., which may be included in the configuration 608 for the report. In aspects, the report 614 is transmitted from the UE 602 and received at the base station 604 via the PUCCH resource(s) identified/specified in the configuration 608 for the report 614. In addition, the report 614 may be repeatedly transmitted via the PUCCH a number of times based on the configuration 608 for the report 614.

It should be noted that while applying the configuration 608 (at 610) is shows as preceding the measuring of the one or more delay statistics (at 612), it is contemplated herein that other temporal relationships between applying the configuration 608 and the measuring of the one or more delay statistics, where applying (at 610) the configuration 608 precedes the provision of the report 614 associated with the traffic for the one or more LCHs from the UE 602 to the base station 604.

FIG. 7 is a flow diagram 700 for adaptive configuration of delay budget in wireless communications, in various aspects. Flow diagram 700 illustrates the arrival of PDUs at a base station and at a UE with respect to latency and jitter.

Flow diagram 700 shows a plurality of PDUs by way of example: a PDU A 702, a PDU B 708, and a PDU C 714. Flow diagram 700 also shows the respective PDUs arriving at a base station and jitter thereof, as well as the respective PDUs arriving at a UE and latency for transmission from the base station. The PDU arrivals are associated with respective delivery deadlines (e.g., associated with an e2e PDB for the UE) and nominal arrival times at the base station.

At the base station, by way of example, an arrival 718 of the PDU A 702 is shown with 0 ms (zero milliseconds) jitter, an arrival 720 of the PDU B 708 is shown with ‘−X ms’ of jitter (e.g., a negative amount of jitter), and an arrival 722 of the PDU C 714 is shown with ‘+Y ms’ of jitter (e.g., a positive amount of jitter). At the UE, by way of example, an arrival 724 of the PDU A 702 is shown with a latency of D_{A} ms, an arrival 726 of the PDU B 708 is shown with a latency of D_{B} ms, and an arrival 728 of the PDU C 714 is shown with a latency of D_{C} ms. In addition, the arrival 724 of the PDU A 702 is shown with an e2e PDB 704 (RAN portion) and a RDB portion 706 having a first duration, the arrival 726 of the PDU B 708 is shown with an e2e PDB 710 (RAN portion) and a RDB portion 712 having a second duration, and the arrival 728 of the PDU C 714 is shown with an e2e PDB 716 (RAN portion) and no RDB having no duration (e.g., a duration of 0 (zero)).

As previously noted and as shown in flow diagram 700, a fixed e2e PDB may be an overly-conservative estimate on the true time at which a packet becomes obsolete and is discarded because the e2e PDB is derived based on the maximum jitter that PDUs in a flow may experience, e.g., as shown specifically for the PDU C 714. That is, for the PDU C 714 having a maximum jitter of +Y ms, the corresponding RAN portion of the e2e PDB 716 ends at the delivery deadline and does not allow for any RDB. Thus, in this case, the PDU C 714 must arrive prior to the end of the e2e PDB 716 or be discarded.

As a result of the conservative nature of a fixed e2e PDB, most PDUs may have additional time left (i.e., may have a RDB) before their actual delivery deadline as required by the application is reached. This is seen by way of example for the PDU A 702 and the PDU B 708 through the RDB portion 706 and the RDB portion 712, respectively, as the base station side jitter for these PDUs is less than the maximum jitter. For instance, the PDU A 702 with zero jitter has the arrival 724 to the UE at the end of the e2e PDB 704 (RAN portion) based on the latency D_{A} ms, yet the RDB portion 706 allows for the PDU A 702 extra time to be processed before it becomes obsolete. Likewise, the PDU B 708 with ‘−X’ jitter has the arrival 726 to the UE after the end of the e2e PDB 710 (RAN portion) based on the latency D_{B} ms (which is the highest latency depicted in flow diagram 700), yet the RDB portion 712 allows for the PDU B 708 extra time to be processed before it becomes obsolete.

The aspects described for statistical delay reporting for adaptive configuration of a delay budget advantageously account for the scenarios depicted above and described elsewhere herein. In aspects, utilizing the delay statistics reported/submitted by a UE, the network (e.g., a base station) is configured to adjust the UE's DL delay budget (e.g., an e2e PDB) for an LCH(s) based on the delay statistics and/or statistics of the RDB for that LCH(s) in the report. One possible example of this adjustment may be to add or subtract an adjustment amount to the UE's DL delay budget that is equal to an average of the RDB plus the product of N and the standard deviation of the residual delay budget (e.g., =RDB+(N·std)), where N is a multiplier (e.g., 3) (and it should be noted that the average of a RDB may be negative, according to aspects herein). In other words, accounting for the jitter at the base station arrivals of PDUs enables adaptive configurations of e2e PDBs as the jitter creates scenarios that are not static for the arrivals, but are dynamic in nature. Adjustment of the e2e PDB also enables the UE to advantageously perform early termination of HARQs, discard packets (e.g., PDUs) more quickly and process other traffic, and/or the like, which more efficiently utilizes both UE and network resources.

Accordingly, the e2e PDB 704, the e2e PDB 710, and/or the e2e PDB 716 may be configured by a base station, as described herein, based on delay statistics reported by a UE. The reporting may include one or more delay statistics, which may be associated with multiple LCHs, in response to at least one LCH having an experienced delay that satisfies a threshold. Likewise, the report may include the one or more delay statistics for multiple LCHs in response to the multiple LCHs each having respectively experienced delays based on a comparison between (1) at least one of statistical parameters having smallest values or smallest residual DB s of the multiple LCHs and (2) statistics thresholds. In aspects, the delay statistics may be measured by the UE, for the UE, and may be based on the latencies shown in FIG. 7, the RDBs shown in FIG. 7 (e.g., durations), and/or the like. For instance, measuring delay statistics that correspond to an e2e PDB, e.g., a DB for packet latency, for the traffic associated with LCHs may include measuring a latency as described above, measuring a RDB, for DL traffic associated with a time difference between (1) an end of the DB of the UE that is configured by the network entity and (2) a delivery deadline required by an application for the DL traffic, and/or the like. The delay statistics may include, without limitation, a first order delay statistic, a second order delay statistic, a mean value for the one or more delay statistics taken over a window of time, a variance for the one or more delay statistics taken over the window of time, and/or a standard deviation for the one or more delay statistics taken over the window of time. The window of time may be any duration, may be a default, may be configured, etc.

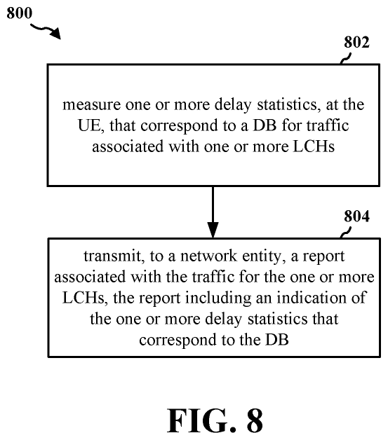

FIG. 8 is a flowchart 800 of a method of wireless communication, in various aspects. The method may be performed by a UE (e.g., the UE 104, 502, 602; the apparatus 1204). At 802, the UE measures one or more delay statistics, at the UE, that correspond to a DB for traffic associated with one or more LCHs. In some aspects, 802 may be performed by the component 198. At 804, the UE transmits, to a network entity, a report associated with the traffic for the one or more LCHs, the report including an indication of the one or more delay statistics that correspond to the DB. In some aspects, 802 may be performed by the component 198.

For instance, referring to FIG. 5, the UE 502 may measure, at 508, one or more delay statistics, at the UE 502, that correspond to a DB (e.g., an e2e DB) for traffic associated with one or more logical channels LCHs. In one configuration, the traffic may include a MAC-PDU, and the one or more delay statistics that correspond to the DB are associated with the MAC-PDU from a LCH of the one or more LCHs. In aspects, a residual delay of the DB may also be measured. In some configurations, the traffic associated with the one or more LCHs may be least one of uplink traffic, downlink traffic, or sidelink traffic (e.g., from another UE acting as a “network entity”). In some aspects, the resources allocated by the CG 506 (e.g., a PUSCH resource(s)) may be present and available for providing a report 514, with delay statistics, that is associated with the traffic for the one or more LCHs. In one configuration, e.g., if such a resource is not available, a scheduling request 510, for a resource to transmit the report 514, may be transmitted to the base station 504. The base station 504 may transmit a DG 512 for the resource to the UE 502 in response to the scheduling request 510. In such aspects, the report 514 may be transmitted to the base station 504 in the resource granted thereby. In either case, the UE 502 may transmit the report 514, with delay statistics, that is associated with the traffic for the one or more LCHs to the base station 504. The report 514 may be comprised in a medium access control (MAC) control element (MAC-CE) on a PUSCH. In various configurations, the delay statistics in the report 514 may include a downlink delay from a first time when a PDCCH for a first TB is received to a second time when first data is delivered to an application, a maximum uplink delay from a third time when second data is generated by the application to a fourth time when a second TB with the second data is transmitted in a PUSCH, and/or the like. In aspects, the report 514 may be transmitted to the base station 504 responsive to, or as triggered by, at least one of a layer 1 (L1), a layer 2 (L2), or a layer 3 (L3) signaling received from the base station 504. In one aspect, the UE 502 is configured to measure an RDB, for downlink (DL) traffic of the traffic, associated with a time difference between (1) an end of the DB of the UE 502 that is configured by the base station 504 and (2) a delivery deadline required by an application for the DL traffic. In aspects, the delay statistics that correspond to the DB may include a first order delay statistic, a second order delay statistic, a mean value for the one or more delay statistics taken over a window of time, a variance for the one or more delay statistics taken over the window of time, or a standard deviation for the one or more delay statistics taken over the window of time. In one configuration, the report 514 may be transmitted to the base station 504 responsive to, or as triggered by a MAC SDU, from an LCH of the one or more LCHs, having an experienced delay at the UE 502 that satisfies a threshold.

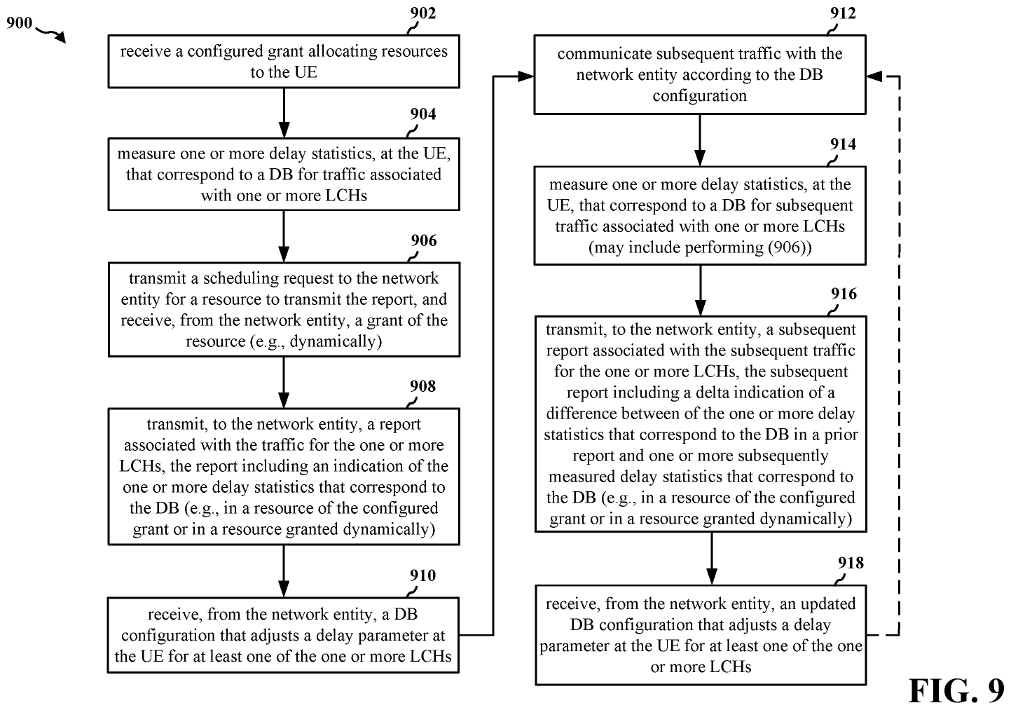

FIG. 9 is a flowchart 900 of a method of wireless communication, in various aspects. The method may be performed by a UE (e.g., the UE 104, 502, 602; the apparatus 1204). At 902, the UE may receive a configured grant allocating resources to the UE. For example, referring to FIG. 5, the UE 502 may receive a CG 506 allocating resources that is transmitted by the base station 504 or one or more components thereof. The CG may be transmitted from base station via RRC, in aspects. In some aspects, 902 may be performed by the component 198.

At 904, the UE may measure one or more delay statistics, at the UE, that correspond to a DB for traffic associated with one or more LCHs. In some aspects, 904 may be performed by the component 198. For example, referring to FIG. 5, the UE 502 may measure, at 508, one or more delay statistics, at the UE 502, that correspond to a DB (e.g., an e2e DB) for traffic associated with one or more logical channels LCHs. In one configuration, the traffic may include a MAC-PDU, and the one or more delay statistics that correspond to the DB are associated with the MAC-PDU from a LCH of the one or more LCHs. In aspects, a residual delay of the DB may also be measured. In some configurations, the traffic associated with the one or more LCHs may be least one of uplink traffic, downlink traffic, or sidelink traffic (e.g., from another UE acting as a “network entity”). In some aspects, 904 may be performed by the component 198.

At 906, the UE may transmit a scheduling request to the network entity for a resource to transmit the report, and receive, from the network entity, a grant of the resource (e.g., dynamically). For example, referring to FIG. 5, the resources allocated by the CG 506 (e.g., a PUSCH resource(s)) may be present and available for providing a report 514, with delay statistics, that is associated with the traffic for the one or more LCHs. In one configuration, e.g., if such a resource is not available, a scheduling request 510, for a resource to transmit the report 514, may be transmitted to the base station 504. The base station 504 may transmit a DG 512 for the resource to the UE 502 in response to the scheduling request 510. In such aspects, the report 514 may be transmitted to the base station 504 in the resource granted thereby. In some aspects, 906 may be performed by the component 198.

At 908, the UE may transmit, to a network entity, a report associated with the traffic for the one or more LCHs, the report including an indication of the one or more delay statistics that correspond to the DB. For example, referring to FIG. 5, in either case for CG or DG resource allocation, the UE 502 may transmit the report 514, with delay statistics, that is associated with the traffic for the one or more LCHs to the base station 504. The report 514 may be comprised in a medium access control (MAC) control element (MAC-CE) on a PUSCH. In various configurations, the delay statistics in the report 514 may include a downlink delay from a first time when a PDCCH for a first TB is received to a second time when first data is delivered to an application, a maximum uplink delay from a third time when second data is generated by the application to a fourth time when a second TB with the second data is transmitted in a PUSCH, and/or the like. In aspects, the report 514 may be transmitted to the base station 504 responsive to, or as triggered by, at least one of a layer 1 (L1), a layer 2 (L2), or a layer 3 (L3) signaling received from the base station 504. In one aspect, the UE 502 is configured to measure an RDB, for downlink (DL) traffic of the traffic, associated with a time difference between (1) an end of the DB of the UE 502 that is configured by the base station 504 and (2) a delivery deadline required by an application for the DL traffic. In aspects, the delay statistics that correspond to the DB may include a first order delay statistic, a second order delay statistic, a mean value for the one or more delay statistics taken over a window of time, a variance for the one or more delay statistics taken over the window of time, or a standard deviation for the one or more delay statistics taken over the window of time. In one configuration, the report 514 may be transmitted to the base station 504 responsive to, or as triggered by a MAC SDU, from an LCH of the one or more LCHs, having an experienced delay at the UE 502 that satisfies a threshold. In some aspects, 908 may be performed by the component 198.

At 910, the UE may receive, from the network entity, a DB configuration that adjusts a delay parameter at the UE for at least one of the one or more LCHs. For example, referring to FIG. 5, based on the report 514, the base station 504 may generate at 516 a DB configuration 518 that adjusts a delay parameter at the UE 502 for at least one of the one or more LCHs. In one configuration, the DB configuration 518 may include an adjustment(s) to lengthen, shorten, or otherwise adjust an e2e PDB of the UE 502, e.g., for the DL DB of the UE 502 (as described in addition detail below with respect to FIG. 7). The DB configuration 518 is transmitted from the base station 504 and received by the UE 502, and the UE 502 implements the configuration to apply the adjustment(s). In some aspects, 910 may be performed by the component 198.

At 912, the UE may communicate subsequent traffic with the network entity according to the DB configuration. For example, referring to FIG. 5, subsequent to applying the DB configuration 518 at the UE 502, the UE 502 may communicate subsequent traffic 520 with the base station 504. The subsequent traffic 520 may be uplink traffic, downlink traffic, and/or sidelink traffic (e.g., with another UE configured as a network entity). In some aspects, 912 may be performed by the component 198.

At 914, the UE may measure one or more delay statistics, at the UE, that correspond to a DB for subsequent traffic associated with one or more LCHs (may include performing (906)). For example, referring to FIG. 5, UE 502 may measure at 522 one or more delay statistics, at the UE 502, that correspond to a DB (e.g., an e2e DB) for the subsequent traffic 520 associated with one or more logical channels LCHs. The UE 502 may be configured to measure the one or more delay statistics that correspond to the DB for the subsequent traffic 520 at 522 as similarly described above (at 508). In some aspects, 914 may be performed by the component 198.

At 916, the UE may transmit, to the network entity, a subsequent report associated with the subsequent traffic for the one or more LCHs, the subsequent report including a delta indication of a difference between of the one or more delay statistics that correspond to the DB in a prior report and one or more subsequently measured delay statistics that correspond to the DB (e.g., in a resource of the configured grant or in a resource granted dynamically). For example, referring to FIG. 5, the UE 502 may generate and transmit a subsequent report 524 associated with the subsequent traffic 520 for the one or more LCHs. In aspects, the subsequent report 524 may include a delta indication of a difference between of the one or more delay statistics that correspond to the DB in a prior report (e.g., report 514) and one or more subsequently measured delay statistics (e.g., at 522) that correspond to the DB. In one configuration, the UE 502 may transmit the subsequent report 524 in resources allocated by the CG 506, while in another configuration, the UE 502 may transmit the subsequent report 524 in resources allocated by the DG 512 (requesting and receiving as described above). In some aspects, 916 may be performed by the component 198.

At 918, the UE may receive, from the network entity, an updated DB configuration that adjusts a delay parameter at the UE for at least one of the one or more LCHs. For example, referring to FIG. 5, based on the subsequent report 524, the base station 504 may generate at 526 an updated DB configuration 528 that adjusts/readjusts a delay parameter at the UE 502 for at least one of the one or more LCHs, e.g., as similarly described above (at 516). The UE 502 may then receive, from the base station 504, and apply the updated DB configuration 528 that adjusts the delay parameter at the UE 502 for at least one of the one or more LCHs. The UE 502 may then communicate further subsequent traffic with the base station 504 according to the updated DB configuration 528. In some aspects, 918 may be performed by the component 198.

After 918, flowchart 900 may return to 912 and continue with additional subsequent communications.

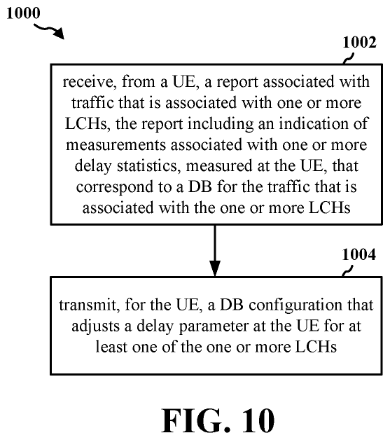

FIG. 10 is a flowchart 1000 of a method of wireless communication, in various aspects. The method may be performed by a base station, a base station, or other network entity (e.g., the base station 102; the base station 504, 604; the network entity 1302; the UE 104 as a network entity via D2D/sidelink communications). At 1002, the network entity receives, from a UE, a report associated with traffic that is associated with one or more LCHs. In aspects, the report includes an indication of measurements associated with one or more delay statistics, measured at the UE, that correspond to a DB for the traffic that is associated with the one or more LCHs. In some aspects, 1002 may be performed by the component 199. At 1004, the network entity transmits, for the UE, a DB configuration that adjusts a delay parameter at the UE for at least one of the one or more LCHs. In some aspects, 1002 may be performed by the component 199.

For example, referring to FIG. 5, the base station 504 receives the report 514, with delay statistics, that is associated with the traffic for the one or more LCHs from the UE 502. The report 514 may be comprised in a medium access control (MAC) control element (MAC-CE) on a PUSCH. In various configurations, the delay statistics in the report 514 may include a downlink delay from a first time when a PDCCH for a first TB is received to a second time when first data is delivered to an application, a maximum uplink delay from a third time when second data is generated by the application to a fourth time when a second TB with the second data is transmitted in a PUSCH, and/or the like. In aspects, the report 514 may be received by the base station 504 responsive to, or as triggered by, at least one of a layer 1 (L1), a layer 2 (L2), or a layer 3 (L3) signaling received from the base station 504. In one configuration, the report 514 may be received by the base station 504 responsive to, or as triggered by a MAC SDU, from an LCH of the one or more LCHs, having an experienced delay at the UE 502 that satisfies a threshold. Based on the report 514, the base station 504 may generate at 516 a DB configuration 518 that adjusts a delay parameter at the UE 502 for at least one of the one or more LCHs. In one configuration, the DB configuration 518 may include an adjustment(s) to lengthen, shorten, or otherwise adjust an e2e PDB of the UE 502, e.g., for the DL DB of the UE 502 (as described in addition detail below with respect to FIG. 7). The DB configuration 518 is transmitted from the base station 504 to the UE 502, and the UE 502 implements the configuration to apply the adjustment(s).

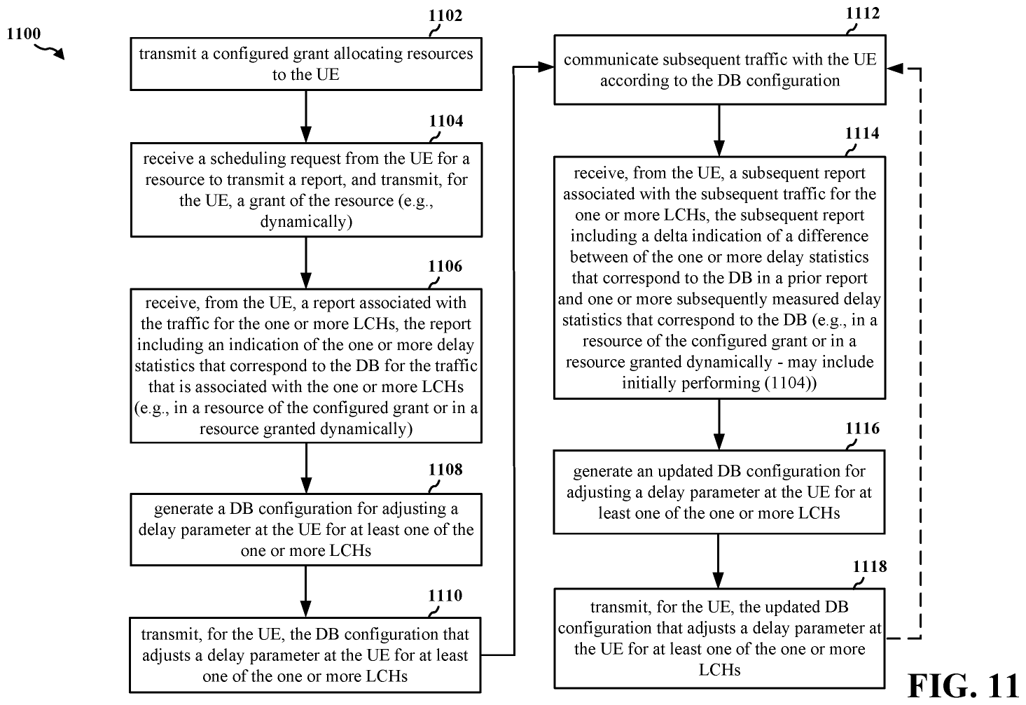

FIG. 11 is a flowchart 1100 of a method of wireless communication, in various aspects. The method may be performed by a base station, a base station, or other network entity (e.g., the base station 102; the base station 504, 604; the network entity 1302; the UE 104 as a network entity via D2D/sidelink communications). At 1102, the network entity may transmit a configured grant allocating resources to the UE. For example, referring to FIG. 5, the base station 504 may transmit a CG 506 allocating resources that is received by the UE 502. The CG may be transmitted from base station via RRC, in aspects. In some aspects, 1102 may be performed by the component 199.

At 1104, the network entity, the network entity may receive a scheduling request from the UE for a resource to transmit a report, and receive, from the network entity, a grant of the resource (e.g., dynamically). For example, referring to FIG. 5, the resources allocated by the CG 506 (e.g., a PUSCH resource(s)) may be present and available for providing a report 514, with delay statistics, that is associated with the traffic for the one or more LCHs. In one configuration, e.g., if such a resource is not available, a scheduling request 510, for a resource to transmit the report 514, may be transmitted to and received by the base station 504 from the UE 502. The base station 504 may transmit a DG 512 for the resource to the UE 502 in response to the scheduling request 510. In such aspects, the report 514 may be transmitted to the base station 504 in the resource granted thereby. In some aspects, 1104 may be performed by the component 199.

At 1106, the network entity may receive, from a UE, a report associated with traffic that is associated with one or more LCHs. In aspects, the report includes an indication of measurements associated with one or more delay statistics, measured at the UE, that correspond to a DB for the traffic that is associated with the one or more LCHs. For example, referring to FIG. 5, the base station 504 receives the report 514, with delay statistics, that is associated with the traffic for the one or more LCHs from the UE 502. The report 514 may be comprised in a MAC-CE on a PUSCH. In various configurations, the delay statistics in the report 514 may include a downlink delay from a first time when a PDCCH for a first TB is received to a second time when first data is delivered to an application, a maximum uplink delay from a third time when second data is generated by the application to a fourth time when a second TB with the second data is transmitted in a PUSCH, and/or the like. In aspects, the report 514 may be received by the base station 504 responsive to, or as triggered by, at least one of an L1, L2, or L3 signaling received from the base station 504. In one configuration, the report 514 may be received by the base station 504 responsive to, or as triggered by a MAC SDU, from an LCH of the one or more LCHs, having an experienced delay at the UE 502 that satisfies a threshold. In some aspects, 1106 may be performed by the component 199.

At 1108, the network entity may generate a DB configuration for adjusting a delay parameter at the UE for at least one of the one or more LCHs. For example, referring to FIG. 5, based on the report 514, the base station 504 may generate at 516 a DB configuration 518 that adjusts a delay parameter at the UE 502 for at least one of the one or more LCHs. In one configuration, the DB configuration 518 may include an adjustment(s) to lengthen, shorten, or otherwise adjust an e2e PDB of the UE 502, e.g., for the DL DB of the UE 502 (as described in addition detail below with respect to FIG. 7). In some aspects, 1108 may be performed by the component 199.

At 1110, the network entity may transmit, for the UE, a DB configuration that adjusts a delay parameter at the UE for at least one of the one or more LCHs. For example, referring to FIG. 5, The DB configuration 518 is transmitted from the base station 504 to the UE 502, and the UE 502 implements the configuration to apply the adjustment(s). In some aspects, 1110 may be performed by the component 199.

At 1112, the network entity may communicate subsequent traffic with the UE according to the DB configuration. For example, referring to FIG. 5, subsequent to applying the DB configuration 518 at the UE 502, the base station 504 may communicate subsequent traffic 520 with the UE 502. The subsequent traffic 520 may be uplink traffic, downlink traffic, and/or sidelink traffic (e.g., with another UE configured as a network entity). In some aspects, 1112 may be performed by the component 199.

At 1114, the network entity may receive, from the UE, a subsequent report associated with the subsequent traffic for the one or more LCHs, the subsequent report including a delta indication of a difference between of the one or more delay statistics that correspond to the DB in a prior report and one or more subsequently measured delay statistics that correspond to the DB (e.g., in a resource of the configured grant or in a resource granted dynamically which may include initially performing (1104)). For example, referring to FIG. 5, the UE 502 may generate and transmit a subsequent report 524 associated with the subsequent traffic 520 for the one or more LCHs, which is received by the base station 504. In aspects, the subsequent report 524 may include a delta indication of a difference between of the one or more delay statistics that correspond to the DB in a prior report (e.g., report 514) and one or more subsequently measured delay statistics (e.g., at 522) that correspond to the DB. In one configuration, the UE 502 may transmit and the base station 504 may receive the subsequent report 524 in resources allocated by the CG 506, while in another configuration, the UE 502 may transmit and the base station 504 may receive the subsequent report 524 in resources allocated by the DG 512 (requesting and receiving as described above). In some aspects, 1114 may be performed by the component 199.

At 1116, the network entity may generate an updated DB configuration for adjusting a delay parameter at the UE for at least one of the one or more LCHs. For example, referring to FIG. 5, based on the subsequent report 524, the base station 504 may generate at 526 an updated DB configuration 528 that adjusts/readjusts a delay parameter at the UE 502 for at least one of the one or more LCHs, e.g., as similarly described above (at 516). In some aspects, 1116 may be performed by the component 199.

At 1118, the network entity. For example, referring to FIG. 5, the base station 504 may transmit to the UE 502 the updated DB configuration 528, for application thereof at the UE 502, that adjusts the delay parameter at the UE 502 for at least one of the one or more LCHs. The base station 504 may then communicate further subsequent traffic with the UE 502 according to the updated DB configuration 528. In some aspects, 1118 may be performed by the component 199.

After 1118, flowchart 1100 may return to 1112 and continue with additional subsequent communications.

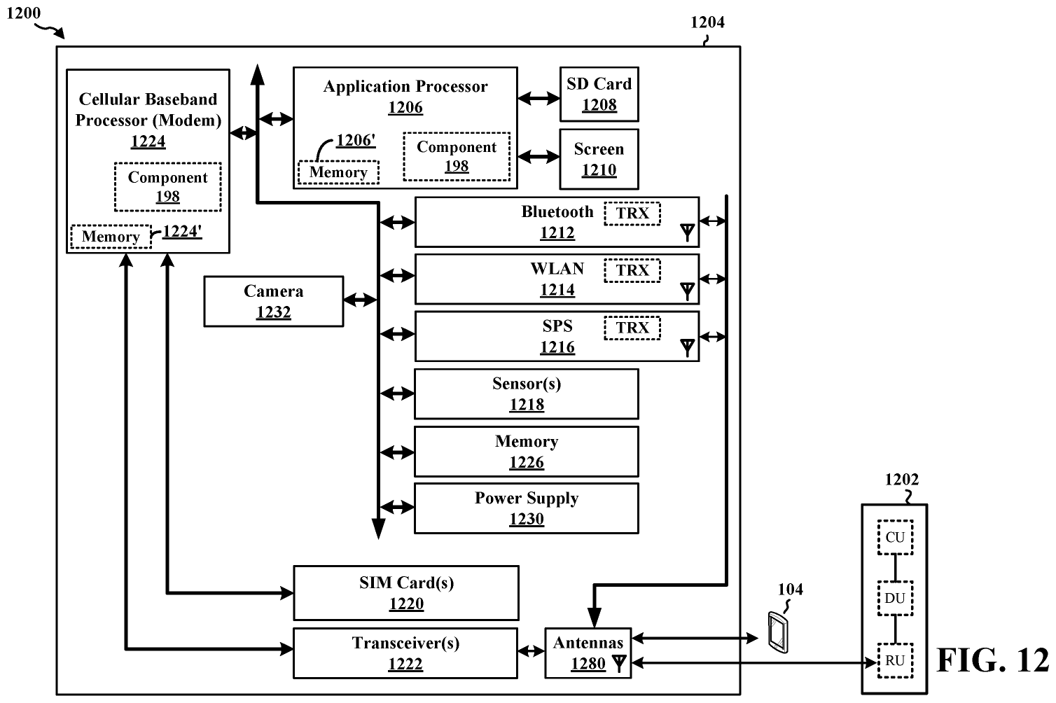

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the component 198 is configured to measure one or more delay statistics, at the UE, that correspond to a delay budget (DB) for traffic associated with one or more logical channels (LCHs). The component 198 is also configured to transmit, to a network entity, a report associated with the traffic for the one or more LCHs, the report including an indication of the one or more delay statistics that correspond to the DB. The component 198 may be configured to transmit a scheduling request to the network entity for a resource to transmit the report, and receive, from the network entity, a grant of the resource. The component 198 may be configured to transmit the report in the resource granted by the network entity. The component 198 may be configured to receive, prior to transmitting the report, a configured grant allocating resources to the UE. The component 198 may be configured to transmit the report in another resource of the configured grant. The component 198 may be configured to transmit, to the network entity, a subsequent report associated with subsequent traffic for the one or more LCHs, the subsequent report including a delta indication of a difference between of the one or more delay statistics that correspond to the DB in a prior report and one or more subsequently measured delay statistics that correspond to the DB. The component 198 may be configured to measure a residual DB, for DL traffic of the traffic, associated with a time difference between (1) an end of the DB of the UE that is configured by the network entity and (2) a delivery deadline required by an application for the DL traffic. The component 198 may be configured to receive, from the network entity via at least one transceiver, a DB configuration that adjusts a delay parameter at the UE for at least one of the one or more LCHs, and to communicate further subsequent traffic with the network entity according to the DB configuration via the at least one transceiver. The component 198 may be configured to receive, from the network entity, a configuration for the report of the one or more delay statistics, the configuration including at least one physical uplink control channel (PUCCH) resource for the report. The component 198 may be configured to transmit the report via the at least one PUCCH resource. The component 198 may be further configured to perform any of the aspects described in connection with FIGS. 8, 9, 10, 11, and/or performed by the UE in FIGS. 5, 6. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular, the cellular baseband processor 1224 and/or the application processor 1206, includes means for measuring one or more delay statistics, at the UE, that correspond to a delay budget (DB) for traffic associated with one or more LCHs. In the configuration, the apparatus 1204, and in particular the cellular baseband processor 1224 and/or the application processor 1206, includes means for transmitting, to a network entity, a report associated with the traffic for the one or more LCHs, the report including an indication of the one or more delay statistics that correspond to the DB. In one configuration, the apparatus 1204, and in particular the cellular baseband processor 1224 and/or the application processor 1206, includes means for transmitting a scheduling request to the network entity for a resource to transmit the report. In one configuration, the apparatus 1204, and in particular the cellular baseband processor 1224 and/or the application processor 1206, includes means for receiving, from the network entity, a grant of the resource, where transmitting the report includes transmitting the report in the resource granted by the network entity. In one configuration, the apparatus 1204, and in particular the cellular baseband processor 1224 and/or the application processor 1206, includes means for receiving, prior to transmitting the report, a configured grant allocating resources to the UE, where transmitting the report includes transmitting the report in a resource of the configured grant. In one configuration, the apparatus 1204, and in particular the cellular baseband processor 1224 and/or the application processor 1206, includes means for transmitting, to the network entity, a subsequent report associated with subsequent traffic for the one or more LCHs, the subsequent report including a delta indication of a difference between of the one or more delay statistics that correspond to the DB in a prior report and one or more subsequently measured delay statistics that correspond to the DB. In one configuration, the apparatus 1204, and in particular the cellular baseband processor 1224 and/or the application processor 1206, includes means for measuring a residual DB, for downlink (DL) traffic of the traffic, associated with a time difference between (1) an end of the DB of the UE that is configured by the network entity and (2) a delivery deadline required by an application for the DL traffic. In one configuration, the apparatus 1204, and in particular the cellular baseband processor 1224 and/or the application processor 1206, includes means for receiving, from the network entity via at least one transceiver of the apparatus, a DB configuration that adjusts a delay parameter at the UE for at least one of the one or more LCHs, and means for communicating subsequent traffic with the network entity according to the DB configuration via the at least one transceiver In one configuration, the apparatus 1204, and in particular the cellular baseband processor 1224 and/or the application processor 1206, includes means for receiving, from the network entity, a configuration for the report of the one or more delay statistics, the configuration including at least one physical uplink control channel (PUCCH) resource for the report, where transmitting the report includes transmitting the report via the at least one PUCCH resource. The application processor 1206 may further include means for performing any of the aspects described in connection with FIGS. 8, 9, 10, 11, and/or performed by the UE in FIGS. 5, 6. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

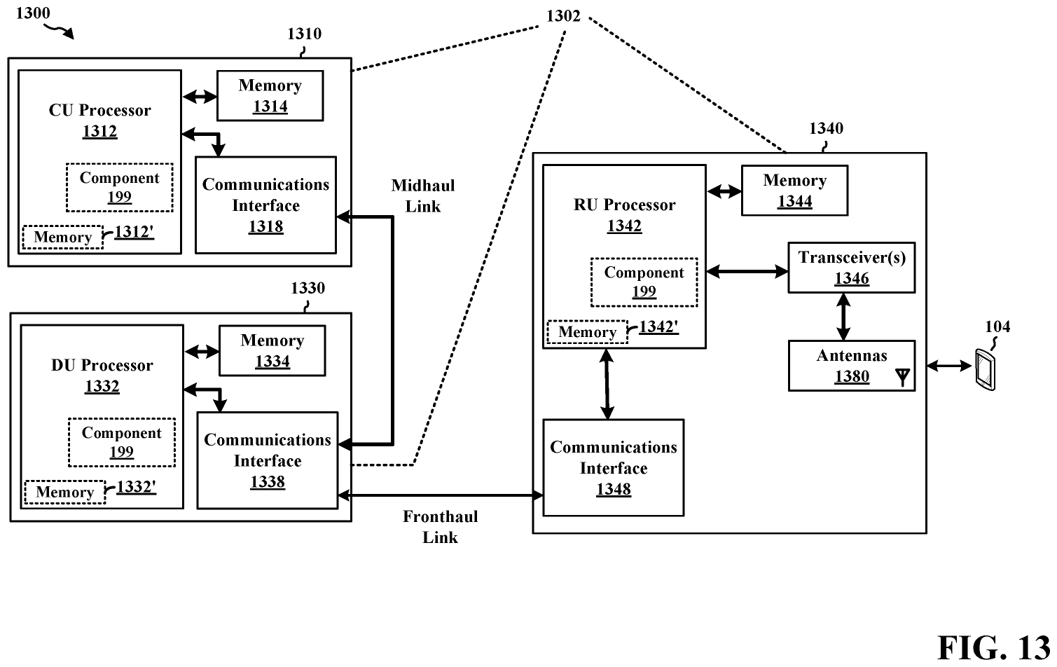

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive, from a user equipment (UE), a report associated with traffic that is associated with one or more logical channels (LCHs), the report including an indication of measurements associated with one or more delay statistics, measured at the UE, that correspond to a delay budget (DB) for the traffic that is associated with the one or more LCHs. The component 199 is also configured to transmit, for the UE, a DB configuration that adjusts a delay parameter at the UE for at least one of the one or more LCHs. The component 199 may also be configured to receive, from a user equipment (UE), a report associated with traffic that is associated with one or more logical channels (LCHs), the report including an indication of measurements associated with one or more delay statistics, measured at the UE, that correspond to a delay budget (DB) for the traffic that is associated with the one or more LCHs. The component 199 may also be configured to transmit, for the UE, a DB configuration that adjusts a delay parameter at the UE for at least one of the one or more LCHs. The component 199 may also be configured to receive a scheduling request, from the UE and via at least one transceiver of the apparatus, for a resource for transmission of the report. The component 199 may also be configured to transmit, to the UE via the at least one transceiver, a grant of the resource responsive to the scheduling request. The component 199 may also be configured to transmit, prior to receiving the report and via the at least one transceiver, a configured grant allocating resources to the UE. The component 199 may also be configured to receive the report in another resource of the configured grant. The component 199 may also be configured to transmit, for the UE, an updated DB configuration that adjusts the delay parameter at the UE for the at least one of the one or more LCHs based on a subsequent report received from the UE that is associated with subsequent traffic for the one or more LCHs, the subsequent report including a delta indication of a difference between of the one or more delay statistics that correspond to the DB and one or subsequently measured more delay statistics that correspond to the DB. The component 199 may also be configured to communicate further subsequent traffic with the UE according to the DB configuration. The component 199 may also be configured to transmit, for the UE, a configuration for the report for the one or more delay statistics, the configuration including at least one physical uplink control channel (PUCCH) resource for the report, where the PUCCH configuration includes at least one of: a periodicity for a periodic report to be transmitted on the at least one PUCCH resource, a code point mapping that maps values of a statistical parameter to a value in a payload of the at least one PUCCH resource, a threshold to trigger an aperiodic report on the at least one PUCCH resource, or a repetition parameter for a repeated transmission of the report. The component 199 may be further configured to perform any of the aspects described in connection with FIGS. 8, 9, 10, 11, and/or performed by the network entity (e.g., a gNB; a UE configured as a network entity) in FIGS. 5, 6. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for receiving, from a UE, a report associated with traffic that is associated with one or more LCHs, the report including an indication of measurements associated with one or more delay statistics, measured at the UE, that correspond to a DB for the traffic that is associated with the one or more LCHs. In the configuration, the network entity 1302 includes means for transmitting, for the UE, a DB configuration that adjusts a delay parameter at the UE for at least one of the one or more LCHs. In one configuration, the network entity 1302 may also include means for receiving a scheduling request, from the UE and via at least one transceiver of the apparatus, for a resource for transmission of the report, and means for transmitting, to the UE via the at least one transceiver, a grant of the resource responsive to the scheduling request. In one configuration, the network entity 1302 may also include means for transmitting, prior to receiving the report and via the at least one transceiver, a configured grant allocating resources to the UE, where receiving the report includes receiving the report in another resource of the configured grant. In one configuration, the network entity 1302 may also include means for transmitting, for the UE, an updated DB configuration that adjusts the delay parameter at the UE for the at least one of the one or more LCHs based on a subsequent report received from the UE that is associated with subsequent traffic for the one or more LCHs, the subsequent report including a delta indication of a difference between of the one or more delay statistics that correspond to the DB and one or subsequently measured more delay statistics that correspond to the DB. In one configuration, the network entity 1302 may also include means for communicating further subsequent traffic with the UE according to the DB configuration. In one configuration, the network entity 1302 may also include means for transmitting, for the UE, a configuration for the report for the one or more delay statistics, the configuration including at least one physical uplink control channel (PUCCH) resource for the report, where the PUCCH configuration includes at least one of: a periodicity for a periodic report to be transmitted on the at least one PUCCH resource, a code point mapping that maps values of a statistical parameter to a value in a payload of the at least one PUCCH resource, a threshold to trigger an aperiodic report on the at least one PUCCH resource, or a repetition parameter for a repeated transmission of the report. The network entity 1302 may include means for performing any of the aspects described in connection with FIGS. 8, 9, 10, 11, and/or performed by the network entity (e.g., base station, a component of a base station; a UE configured as a network entity) in FIGS. 5, 6. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

Some aspects of wireless communications may provide for a fixed e2e packet DB between a UE and an application server, for uplink and downlink communications, after which data packets become obsolete and are discarded. The fixed e2e packet DB (or e2e “PDB”), however, may be a conservative estimate of data packet obsolescence due to jitter experienced during communications through the network. Some flows generated by XR and other applications have tight deadlines given the requirements of the user experience for such applications and the bandwidth required for the data flows—packets in these flows become obsolete to the application once their packet delay exceeds the e2e PDB. While delay sensitive UL traffic may be transmitted via configured grant resources, which may be sufficient for small-sized, constant data-rate flows (e.g., pose), dynamic grant resources may still be needed to handle larger, high data-rate flows (e.g., video) in order to efficiently use radio resources. The e2e PDB between a UE and an application server may be insufficient to serve as a guideline for preventing packet obsolescence, and may be not practical for a UE to apply in its L2 procedures. The described aspects enable a UE to measure and report UE delay statistics that correspond to a DB for traffic associated with one or more LCHs and to then implement adaptive configurations of DB s for adjustments thereof, which allows improved communications and management of data packets in flows (e.g., XR) to prevent the data packets from becoming obsolete to an application and discarded once their delay exceeds the DB. In addition, aspects provide for dynamic grants to report delay statistics, as well as configurations for PUCCH resource for reporting, and provide flexibility in report triggering based on network signaling as well as experienced delay at the UE that satisfies a threshold. The described aspects also improve efficiency in the use of radio resources, e.g., in handling large, high data-rate flows such as video (e.g., in XR).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: measuring one or more delay statistics, at the UE, that correspond to a delay budget (DB) for traffic associated with one or more logical channels (LCHs), and transmitting, to a network entity, a report associated with the traffic for the one or more LCHs, the report including an indication of the one or more delay statistics that correspond to the DB.

Aspect 2 is the method of aspect 1, where the report is comprised in a medium access control (MAC) control element (MAC-CE) on a physical uplink shared channel (PUSCH).

Aspect 3 is the method of any of aspects 1 and 2, where transmitting the report is performed responsive to at least one of: a layer 1 (L1), a layer 2 (L2), or a layer 3 (L3) signaling received from the network entity, or a MAC service data unit (MAC SDU), from a LCH of the one or more LCHs, having an experienced delay at the UE that satisfies a threshold.

Aspect 4 is the method of any of aspects 1 to 3, where transmitting the report includes reporting the one or more delay statistics for multiple LCHs in response to at least one LCH having an experienced delay that satisfies a threshold.

Aspect 5 is the method of any of aspects 1 to 4, where the method further includes: transmitting a scheduling request to the network entity for a resource to transmit the report, and receiving, from the network entity, a grant of the resource, where transmitting the report includes transmitting the report in the resource granted by the network entity.

Aspect 6 is the method of any of aspects 1 to 4, where the method further includes: receiving, prior to transmitting the report, a configured grant allocating resources to the UE, where transmitting the report includes transmitting the report in a resource of the configured grant.

Aspect 7 is the method of any of aspects 1 to 6, where the method further includes: transmitting, to the network entity, a subsequent report associated with subsequent traffic for the one or more LCHs, the subsequent report including a delta indication of a difference between of the one or more delay statistics that correspond to the DB in a prior report and one or more subsequently measured delay statistics that correspond to the DB.

Aspect 8 is the method of any of aspects 1 to 7, where the one or more delay statistics that correspond to the DB are associated with a MAC protocol data unit (MAC-PDU) from a LCH of the one or more LCHs, and where the one or more delay statistics that correspond to the DB include at least one of: a first order delay statistic, a second order delay statistic, a mean value for the one or more delay statistics taken over a window of time, a variance for the one or more delay statistics taken over the window of time, or a standard deviation for the one or more delay statistics taken over the window of time.

Aspect 9 is the method of any of aspects 1 to 8, where the one or more delay statistics that correspond to the DB are associated with at least one of: a downlink delay from a first time when a physical downlink control channel (PDCCH) for a first transport block (TB) is received to a second time when first data is delivered to an application, or a maximum uplink delay from a third time when second data is generated by the application to a fourth time when a second TB with the second data is transmitted in a physical uplink shared channel (PUSCH).

Aspect 10 is the method of any of aspects 1 to 9, where measuring the one or more delay statistics that correspond to the DB for the traffic associated with the one or more LCHs includes measuring a residual DB, for downlink (DL) traffic of the traffic, associated with a time difference between (1) an end of the DB of the UE that is configured by the network entity and (2) a delivery deadline required by an application for the DL traffic.

Aspect 11 is the method of any of aspects 1 to 9, where the traffic associated with the one or more LCHs is at least one of uplink traffic, downlink traffic, or sidelink traffic, and where the method further includes: receiving, from the network entity via at least one transceiver of the apparatus, a DB configuration that adjusts a delay parameter at the UE for at least one of the one or more LCHs, and communicating subsequent traffic with the network entity according to the DB configuration via the at least one transceiver.

Aspect 12 is the method of any of aspects 1 and 3 to 11, where the method further includes: receiving, from the network entity, a configuration for the report of the one or more delay statistics, the configuration including at least one physical uplink control channel (PUCCH) resource for the report, where transmitting the report includes transmitting the report via the at least one PUCCH resource.

Aspect 13 is the method of aspect 12, where the configuration for the report of the one or more delay statistics further includes at least one of: a periodicity for a periodic report to be transmitted on the at least one PUCCH resource, a code point mapping that maps values of a statistical parameter to a value in a payload of the at least one PUCCH resource, a threshold to trigger an aperiodic report on the at least one PUCCH resource, or a repetition parameter for a repeated transmission of the report.

Aspect 14 is a method of wireless communication at a network entity, comprising: receiving, from a user equipment (UE), a report associated with traffic that is associated with one or more logical channels (LCHs), the report including an indication of measurements associated with one or more delay statistics, measured at the UE, that correspond to a delay budget (DB) for the traffic that is associated with the one or more LCHs, and transmitting, for the UE, a DB configuration that adjusts a delay parameter at the UE for at least one of the one or more LCHs.

Aspect 15 is the method of aspect 14, where the report is comprised in a medium access control (MAC) control element (MAC-CE) on a physical uplink shared channel (PUSCH) responsive to at least one of: a layer 1 (L1), a layer 2 (L2), or a layer 3 (L3) signaling received from the network entity, or a MAC service data unit (MAC SDU), from a LCH of the one or more LCHs, having experienced delay at the UE that satisfies a threshold.

Aspect 16 is the method of any of aspects 14 and 15, where the report includes the one or more delay statistics for multiple LCHs in response to at least one LCH having an experienced delay that satisfies a threshold.

Aspect 17 is the method of any of aspects 14 to 16, where the method further includes: receiving a scheduling request, from the UE and via at least one transceiver of the apparatus, for a resource for transmission of the report, and transmitting, to the UE via the at least one transceiver, a grant of the resource responsive to the scheduling request; or where the method further includes transmitting, prior to receiving the report and via the at least one transceiver, a configured grant allocating resources to the UE, where receiving the report includes receiving the report in another resource of the configured grant.

Aspect 18 is the method of any of aspects 14 to 17, where the method further includes: transmitting, for the UE, an updated DB configuration that adjusts the delay parameter at the UE for the at least one of the one or more LCHs based on a subsequent report received from the UE that is associated with subsequent traffic for the one or more LCHs, the subsequent report including a delta indication of a difference between of the one or more delay statistics that correspond to the DB and one or subsequently measured more delay statistics that correspond to the DB, and communicating further subsequent traffic with the UE according to the DB configuration.

Aspect 19 is the method of any of aspects 14 to 18, where the one or more delay statistics that correspond to the DB are associated with at least one of: a downlink delay from a first time when a physical downlink control channel (PDCCH) for a first transport block (TB) is received to a second time when first data is delivered to an application, or a maximum uplink delay from a third time when second data is generated by the application to a fourth time when a second TB with the second data is transmitted in a physical uplink shared channel (PUSCH); or where the method further includes: transmitting, for the UE, a configuration for the report for the one or more delay statistics, the configuration including at least one physical uplink control channel (PUCCH) resource for the report, where the PUCCH configuration includes at least one of: a periodicity for a periodic report to be transmitted on the at least one PUCCH resource, a code point mapping that maps values of a statistical parameter to a value in a payload of the at least one PUCCH resource, a threshold to trigger an aperiodic report on the at least one PUCCH resource, or a repetition parameter for a repeated transmission of the report.

Aspect 20 is an apparatus for wireless communication configured to implement any of aspects 1 to 19.

Aspect 21 is an apparatus for wireless communication including means for implementing any of aspects 1 to 19.

Aspect 22 is a computer-readable medium (e.g., a non-transitory computer-readable medium) storing computer executable code, the code when executed by at least one processor causes the at least one processor to implement any of aspects 1 to 19.

What is claimed is:

1. A apparatus for wireless communication at a user equipment (UE), comprising:
a memory; and
at least one processor coupled to the memory and, based at least in part on information stored in the memory, the at least one processor is configured to:
measure one or more delay statistics, at the UE, that correspond to a delay budget (DB) for traffic associated with one or more logical channels (LCHs); and
transmit, to a network entity, a report associated with the traffic for the one or more LCHs, the report including an indication of the one or more delay statistics that correspond to the DB.

2. The apparatus of claim 1, wherein the report is comprised in a medium access control (MAC) control element (MAC-CE) on a physical uplink shared channel (PUSCH).

3. The apparatus of claim 2, wherein to transmit the report, the at least one processor is configured to transmit the report responsive to at least one of:
a layer 1 (L1), a layer 2 (L2), or a layer 3 (L3) signaling received from the network entity; or
a MAC service data unit (MAC SDU), from a LCH of the one or more LCHs, having an experienced delay at the UE that satisfies a threshold.

4. The apparatus of claim 2, wherein to transmit the report, the at least one processor is configured to: report the one or more delay statistics for multiple LCHs in response to at least one LCH having an experienced delay that satisfies a threshold.

5. The apparatus of claim 1, wherein the at least one processor is further configured to:
transmit a scheduling request to the network entity for a resource to transmit the report; and
receive, from the network entity, a grant of the resource,
wherein to transmit the report, the at least one processor is configured to transmit the report in the resource granted by the network entity.

6. The apparatus of claim 1, wherein the at least one processor is further configured to:
receive, prior to the report being transmitted, a configured grant that allocates resources to the UE, wherein to transmit the report, the at least one processor is configured to transmit the report in a resource of the configured grant.

7. The apparatus of claim 1, wherein the at least one processor is further configured to:
transmit, to the network entity, a subsequent report associated with subsequent traffic for the one or more LCHs, the subsequent report including a delta indication of a difference between of the one or more delay statistics that correspond to the DB in a prior report and one or more subsequently measured delay statistics that correspond to the DB.

8. The apparatus of claim 1, wherein the one or more delay statistics that correspond to the DB are associated with a MAC protocol data unit (MAC-PDU) from a LCH of the one or more LCHs; and
wherein the one or more delay statistics that correspond to the DB include at least one of:
a first order delay statistic,
a second order delay statistic,
a mean value for the one or more delay statistics taken over a window of time,
a variance for the one or more delay statistics taken over the window of time, or
a standard deviation for the one or more delay statistics taken over the window of time.

9. The apparatus of claim 1, wherein the one or more delay statistics that correspond to the DB are associated with at least one of:
a downlink delay from a first time when a physical downlink control channel (PDCCH) for a first transport block (TB) is received to a second time when first data is delivered to an application, or
a maximum uplink delay from a third time when second data is generated by the application to a fourth time when a second TB with the second data is transmitted in a physical uplink shared channel (PUSCH).

10. The apparatus of claim 1, wherein to measure the one or more delay statistics that correspond to the DB for the traffic associated with the one or more LCHs, the at least one processor is configured to:
measure a residual DB, for downlink (DL) traffic of the traffic, associated with a time difference between (1) an end of the DB of the UE that is configured by the network entity and (2) a delivery deadline required by an application for the DL traffic.

11. The apparatus of claim 1, wherein the traffic associated with the one or more LCHs is at least one of uplink traffic, downlink traffic, or sidelink traffic; and
wherein the at least one processor is further configured to:
receive, from the network entity, a DB configuration that adjusts a delay parameter at the UE for at least one of the one or more LCHs, and
communicate subsequent traffic with the network entity according to the DB configuration.

12. The apparatus of claim 1, wherein the at least one processor is further configured to:
receive, from the network entity, a configuration for the report of the one or more delay statistics, the configuration including at least one physical uplink control channel (PUCCH) resource for the report,
wherein to transmit the report, the at least one processor is configured to transmit the report via the at least one PUCCH resource.

13. The apparatus of claim 12, wherein the configuration for the report of the one or more delay statistics further includes at least one of:
a periodicity for a periodic report to be transmitted on the at least one PUCCH resource,
a code point mapping that maps values of a statistical parameter to a value in a payload of the at least one PUCCH resource,
a threshold to trigger an aperiodic report on the at least one PUCCH resource, or
a repetition parameter for a repeated transmission of the report.

14. A apparatus for wireless communication at a network entity, comprising:
a memory; and
at least one processor coupled to the memory and, based at least in part on information stored in the memory, the at least one processor is configured to:
receive, from a user equipment (UE), a report associated with traffic that is associated with one or more logical channels (LCHs), the report including an indication of measurements associated with one or more delay statistics, measured at the UE, that correspond to a delay budget (DB) for the traffic that is associated with the one or more LCHs; and
transmit, for the UE, a DB configuration that adjusts a delay parameter at the UE for at least one of the one or more LCHs.

15. The apparatus of claim 14, wherein the report is comprised in a medium access control (MAC) control element (MAC-CE) on a physical uplink shared channel (PUSCH) responsive to at least one of:
a layer 1 (L1), a layer 2 (L2), or a layer 3 (L3) signaling received from the network entity, or
a MAC service data unit (MAC SDU), from a LCH of the one or more LCHs, having experienced delay at the UE that satisfies a threshold.

16. The apparatus of claim 14, wherein the report includes the one or more delay statistics for multiple LCHs in response to at least one LCH having an experienced delay that satisfies a threshold.

17. The apparatus of claim 14, wherein the at least one processor is further configured to:
receive a scheduling request, from the UE, for a resource for transmission of the report, and
transmit, to the UE, a grant of the resource responsive to the scheduling request; or
transmit, prior to the report being received, a configured grant allocating resources to the UE, wherein to receive the report, the at least one processor is configured to receive the report in another resource of the configured grant.

18. The apparatus of claim 14, wherein the at least one processor is further configured to:
transmit, for the UE, an updated DB configuration that adjusts the delay parameter at the UE for the at least one of the one or more LCHs based on a subsequent report received from the UE that is associated with subsequent traffic for the one or more LCHs, the subsequent report including a delta indication of a difference between of the one or more delay statistics that correspond to the DB and one or subsequently measured more delay statistics that correspond to the DB, and
communicate further subsequent traffic with the UE according to the DB configuration.

19. The apparatus of claim 14, wherein the one or more delay statistics that correspond to the DB are associated with at least one of:
a downlink delay from a first time when a physical downlink control channel (PDCCH) for a first transport block (TB) is received to a second time when first data is delivered to an application, or
a maximum uplink delay from a third time when second data is generated by the application to a fourth time when a second TB with the second data is transmitted in a physical uplink shared channel (PUSCH); or
wherein the at least one processor is further configured to:
transmit, for the UE, a configuration for the report for the one or more delay statistics, the configuration including at least one physical uplink control channel (PUCCH) resource for the report;
wherein the PUCCH configuration includes at least one of:
a periodicity for a periodic report to be transmitted on the at least one PUCCH resource,
a code point mapping that maps values of a statistical parameter to a value in a payload of the at least one PUCCH resource,
a threshold to trigger an aperiodic report on the at least one PUCCH resource, or
a repetition parameter for a repeated transmission of the report.

20. A method for wireless communication at a user equipment (UE), comprising:
measuring one or more delay statistics, at the UE, that correspond to a delay budget (DB) for traffic associated with one or more logical channels (LCHs); and
transmitting, to a network entity, a report associated with the traffic for the one or more LCHs, the report including an indication of the one or more delay statistics that correspond to the DB.
